(19) United States
(12) Patent Application Publication
(10) Pub. No.: US 2020/0393043 A1
(43) Pub. Date: Dec. 17, 2020

(54) MOTOR WITH SPEED REDUCER

(71) Applicant: SHINANO KENSHI KABUSHIKI KAISHA, Nagano (JP)

(72) Inventor: Hiroshi UEHARA, Nagano (JP)

(21) Appl. No.: 16/831,496

(22) Filed: Mar. 26, 2020

(30) Foreign Application Priority Data
Jun. 17, 2019 (JP) 2019-111957

(51) Int. Cl. F16H 63/30

(52) U.S. Cl. CPC F16H 63/304; F16H 2057/02073

(57) ABSTRACT

The motor is formed to have an outer diameter larger than an outer diameter of a speed reducer, and an electromagnetic clutch mechanism, which is configured to switch the state of an output-side member (movable member) disposed downstream of an output member in a drive transmission path between a drive transmission state and a drive cut-off state from the output member of the speed reducer, is disposed in the axial projection space of a motor with respect to the speed reducer.

### CROSS-REFERENCE TO RELATED APPLICATION

This application is based upon and claims the benefit of priority of the prior Japanese Patent Application No. 2019-111957, filed on Jun. 17, 2019, and the entire contents of which are incorporated herein by reference.

### TECHNICAL FIELD

The present invention relates to a motor with a speed reducer provided with an electromagnetic clutch mechanism configured to switch a state of, for example, an output member between a drive transmission state and a drive cut-off state.

### BACKGROUND ART

The motor with a speed reducer is provided with a speed reducer configured to rotate a gear mechanism at a reduced speed about an eccentric shaft which is driven to rotate by a motor before output. The speed reducer includes the eccentric shaft configured to be driven to rotate by the motor, an internal gear provided around an inner peripheral surface of a speed reducer housing, a plurality of external gears eccentrically assembled with respect to the eccentric shaft and configured to be revolved about the eccentric shaft by meshing with the internal gear, the plurality of external gears each including a through hole extending therethrough in an axial direction, output pins provided at a plurality of positions in a circumferential direction so as to extend along the eccentric shaft while passing through and being circumscribed with the through holes, and an output member to which ends of the output pins are coupled and configured to rotate with revolutions of the plurality of external gears via outer bearing provided on the speed reducer housing at a reduced speed (PTL 1: JP-A-2019-35500). This contributes to reduction in size and thickness of the motor with a speed reducer, and cost reduction and long life are achieved by using an inexpensive ball bearing.

### SUMMARY OF INVENTION

### Technical Problem

The motor with a speed reducer described above outputs a power from an input shaft driven by the motor through the output member while amplifying the output. Therefore, even when an attempt is made to move the output member from an output side in a case of power outage or with a motor in a state of standstill, it is impossible to move because a load of the speed reducer is too heavy. In addition, when an electromagnetic clutch is provided on the output member and the speed reducer, an electromagnet, a clutch plate, or the like is provided so that the size in the axial direction is likely to increase, and an installation space is insufficient.

### Solution to Problem

In response to the above issue, one or more aspects of the present invention are directed to a motor with a speed reducer having a compact and flat shape, which is capable of rotating a member on an output side from a speed reducer even when a motor is in the state of standstill, and also capable of achieving reduction in thickness in an axial direction even with an electromagnetic clutch provided thereon.

The disclosure of some embodiments described below includes at least the following configurations. This disclosure provides a motor with a speed reducer, including: a motor configured to drive to rotate an input shaft, and a speed reducer configured to rotate an output member at a reduced speed via a gear mechanism about the input shaft, in which the motor being formed to have an outer diameter larger than an outer diameter of the speed reducer, and an electromagnetic clutch mechanism is disposed in an axial projection space of the motor with respect to the speed reducer to switch the state of the output member of the speed reducer with respect to an output-side member disposed downstream of the output member in a drive transmission path between a drive transmission state and a drive cut-off state. According to the above-described configuration, since the motor is formed to have an outer diameter larger than the outer diameter of the speed reducer, an axial projection space of the motor is generated with respect to the speed reducer. By disposing the electromagnetic clutch mechanism in the axial projection space, which is a free space, a compact and flat motor with a speed reducer which achieves a reduction in thickness in the axial direction. Further, by switching a state of the output member of the speed reducer with respect to the output-side member disposed downstream of the output member in the drive transmission path from the drive transmission state to the drive cut-off state by an electromagnetic clutch, the output-side member can be rotated by the speed reducer even when the motor is in the state of standstill, thereby meeting the needs of a user.

The electromagnetic clutch mechanism may include: a movable member disposed opposite to the output member in the axial direction and provided so as to allow a contact/separation movement with respect to the output member; a movable yoke assembled to the movable member; a stationary yoke including both side leg portions having an angular U-shape disposed opposite to the movable yoke via a clearance; a pair of permanent magnets disposed on part of the stationary yoke in a direction in which the same poles oppose each other; a protrusion disposed on the stationary yoke between the pair of permanent magnets so as to protrude toward the movable yoke; and a pair of coils disposed adjacent to the protrusion and turned in the same direction with air-core portions thereof opposite to the movable yoke, and a direction of energization of the coils may be switched to vary a magnitude of an attraction power of both side leg portions on the stationary yoke and move the movable yoke in the axial direction so that the state of the output-side member may be switched between the drive transmission state and the drive cut-off state. Accordingly, only by switching the direction of energization of an electromagnet, the magnitude of the attraction power between the movable yoke and the stationary yoke in which the both side leg portions are disposed opposite to each other is varied to move the movable yoke in the axial direction together with the output member and switch the state of the output-side member between the drive transmission state and the drive cut-off state. Therefore, even when the motor is in a state of standstill, the output-side member disposed downstream of the speed reducer in the drive transmission path can be rotated by the speed reducer by establishing the drive cut-off state.

A clutch plate may be coaxially provided over the output member, and switching between the drive transmission state and the drive cut-off state is achieved by the contact/separation movement between the movable member and the clutch plate. Accordingly, by moving the movable member in the axial direction, which constitutes the electromagnetic clutch, to make the contact/separation movement with respect to the clutch plate provided on the output member, switching between the drive transmission state and the drive cut-off state is achieved.

As another configuration, this disclosure provides a motor with a speed reducer, including: a motor configured to drive to rotate an input shaft, a speed reducer configured to rotate an output member at a reduced speed via a gear mechanism about the input shaft, and a movable member constantly meshing with the output member, in which the motor being formed to have an outer diameter larger than an outer diameter of the speed reducer, and an electromagnetic clutch mechanism is disposed in an axial projection space of the motor with respect to the speed reducer to achieve switching between a drive transmission state and a drive cut-off state by a contact/separation movement between the movable member and an output-side rotating member disposed downstream of the movable member in a drive transmission path. Accordingly, by causing the movable member meshing with the output member of the speed reducer to make a contact/separation movement with respect to the output-side rotating member disposed downstream of the movable member in the drive transmission path by the electromagnetic clutch and switching from the drive transmission state to the drive cut-off state, the output-side rotating member can be rotated even when the motor is in a state of standstill, thereby meeting the needs of the user.

The speed reducer may include external gears configured to revolve around the input shaft and an internal gear configured to mesh with the external gears, and the output member configured to rotate with the rotation of the external gears relatively at a reduced speed via the internal gear. Accordingly, the rotation of the input shaft is converted into a rotational movement reduced in speed of a plurality of the external gears about the input shaft, or the external gears meshing with a tooth surface on an outer periphery of the input shaft as a sun gear and the internal gear meshing with the external gears may be coaxially assembled into a compact profile, so that flattening of the speed reducer is achieved.

The input shaft may be an eccentric shaft, or a sun gear coupled to a rotor yoke of the motor, and the eccentric shaft or the sun gear may be used as an input to the external gears. The speed reducer may employ both a trochoid reducer configured to rotate the plurality of external gears disposed into a trochoid tooth shape about the eccentric shaft to rotate the output member relatively at a reduced speed via the internal gear and a planetary speed reducer configured to revolve the external gears meshing with the sun gear as planetary gears to rotate the output member relatively at a reduced speed via the internal gear.

### Advantageous Effects of Invention

A compact and flat motor with a speed reducer, in which an output member can be rotated from an output side even when the motor is in a state of standstill, and which achieves a reduction in thickness in an axial direction even with an electromagnetic clutch, may be provided.

### BRIEF DESCRIPTION OF DRAWINGS

FIGS. 1A and 1B are a plan view and a cross-sectional view taken along an arrow X-X in FIG. 1A, respectively, illustrating a motor with a speed reducer, in which an electromagnetic clutch is in a drive cut-off state.

FIGS. 2A and 2B are a plan view and a cross-sectional view taken along an arrow X-X in FIG. 2A, respectively, illustrating the motor with a speed reducer, in which the electromagnetic clutch is in a state of a drive transmission state.

FIGS. 3A, 3B, and 3C are a plan view of an electromagnetic clutch, a cross-sectional view taken along an arrow X-X in FIG. 3A, and a partial enlarged sectional view, respectively, illustrating the electromagnetic clutch.

FIGS. 4A and 4B are a plan view and a cross-sectional view taken along an arrow X-X in FIG. 4A, respectively, illustrating the motor with a speed reducer according to another example.

### DESCRIPTION OF EMBODIMENTS

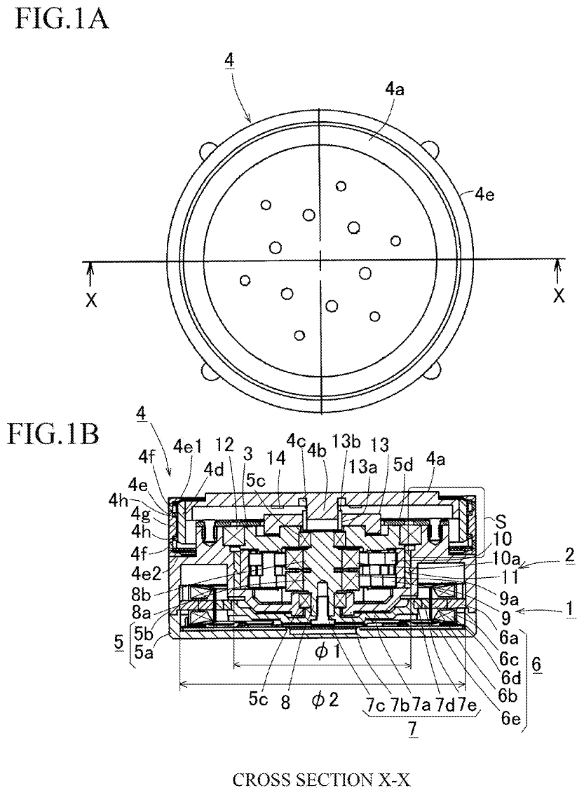

Referring now to attached drawings, an embodiment of a motor with a speed reducer according to the present disclosure will be described. First, a schematic configuration of the motor with a speed reducer will be described with reference to FIGS. 1A to 3C. ADC brushless motor is used as the motor, and an inner rotor-type motor is used in this example.

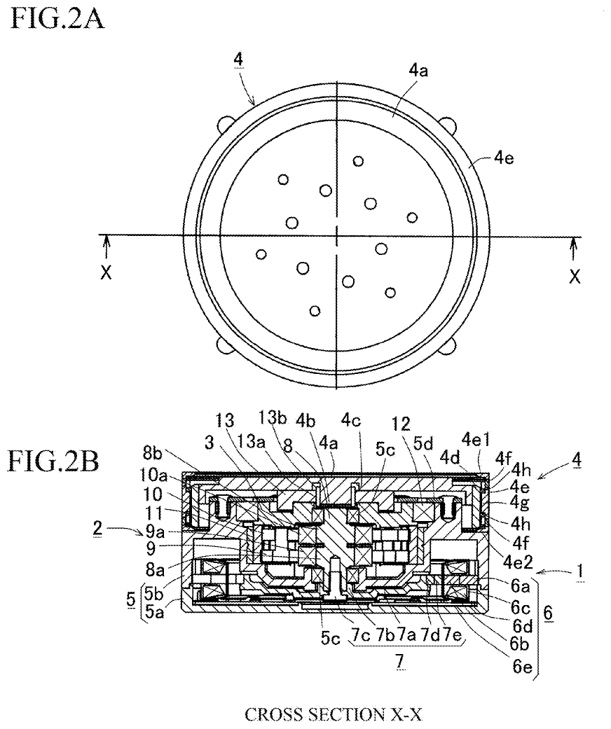

As illustrated in FIGS. 1A and 1B and FIGS. 2A and 2B, the motor with a speed reducer includes a motor 1 configured to drive to rotate an input shaft assembled to a rotor yoke, and a speed reducer 2 for rotating an output member 3 at a reduced speed via a gear mechanism about the input shaft. As illustrated in FIGS. 1A and 1B, an outer diameter ϕ2 of the motor is formed to be larger than an outer diameter ϕ1 of the speed reducer. An electromagnetic clutch mechanism 4, which is configured to switch the state of the speed reducer 2 with respect to the output member 3 between a drive transmission state and a drive cut-off state, is disposed in an axial projection space (free space S) of the motor 1 with respect to the speed reducer 2. By disposing the electromagnetic clutch mechanism 4 in the free space S in this manner, a compact and flat motor with a speed reducer which achieves a reduction in thickness in an axial direction is provided. Further, by switching the speed reducer 2 and the output member 3 from the drive transmission state to the drive cut-off state by the electromagnetic clutch mechanism 4, the output member 3 can be rotated from an output side even when the motor 1 is in a state of standstill, thereby meeting the needs of the user.

A configuration of each part will be described in detail below. The motor 1 is housed in a housing 5 including a motor housing 5a and a speed reducer housing 5b assembled to each other. A stator 6 is assembled to the housing 5. In the stator 6, a coil 6d is wound around a plurality of pole teeth 6b protruding radially inward of a stator core 6a via an insulator 6c. A motor substrate 6e configured to control energization of the coil 6d is provided on an inner wall surface of the motor housing 5a. A lead wire drawn out from the coil 6d is connected to the motor substrate 6e.

A rotor 7 is provided radially inside the stator 6. An end portion of an eccentric shaft 8 on an input side is fitted into a boss portion 7b of a rotor yoke 7a provided at a center of a rotor hub and is fixed by a screw 7c. The eccentric shaft 8 is rotatably supported by a pair of rolling bearings 5c provided on the speed reducer housing 5b and the output member 3. On an outer periphery of the rotor yoke 7a, an annular back yoke 7d and an annular rotor magnet 7e are provided and the rotor magnet 7e is positioned outside the back yoke 7d. The rotor magnet 7e is magnetized with N-poles and S-poles alternately in a circumferential direction and is disposed so as to oppose the pole teeth 6b of the stator core 6a.

The eccentric shaft 8 is provided at a center portion thereof with first and second eccentric cam portions 8a and 8b arranged in line from the input side. The first and second eccentric cam portions 8a and 8b have the same eccentricity with respect to an axial center of the eccentric shaft 8 and are substantially 180 degrees out of phase with each other. A first external gear 9 is rotatably assembled to an outer periphery of the first eccentric cam portion 8a via a first bearing 9a. A second external gear 10 is rotatably assembled to an outer periphery of the second eccentric cam portion 8b via a second bearing 10a. An internal gear 11 is provided on an inner peripheral surface of the speed reducer housing 5b. Parts of the first external gear 9 and the second external gear 10 on the outer peripheral side mesh with the internal gear 11. It should be noted that centers of rotation of the first external gear 9 and the second external gear 10 coincide with a center line of the internal gear 11 provided on an inner peripheral surface of the speed reducer housing 5, and the internal gear 11, the first external gear 9, and the second external gear 10 have a trochoid tooth shape.

An output end of the eccentric shaft 8 is assembled to an inner peripheral surface of the output member 3 via the rolling bearings 5c. An outer peripheral surface of the output member 3, being required to have a load bearing property, is rotatably supported via a cross roller bearing 12 provided between the outer peripheral surface and the speed reducer housing 5b. The cross roller bearing 12 is retained by a holding plate 5d, which is fixed onto an end face of the speed reducer housing 5b with a screw. A clutch plate 13 is coaxially provided integrally on the output side end face of the output member 3. The clutch plate 13 is configured to achieve switching between the drive transmission state and the drive cut-off state by a contact/separation movement with respect to a movable member 4a provided in the electromagnetic clutch mechanism 4.

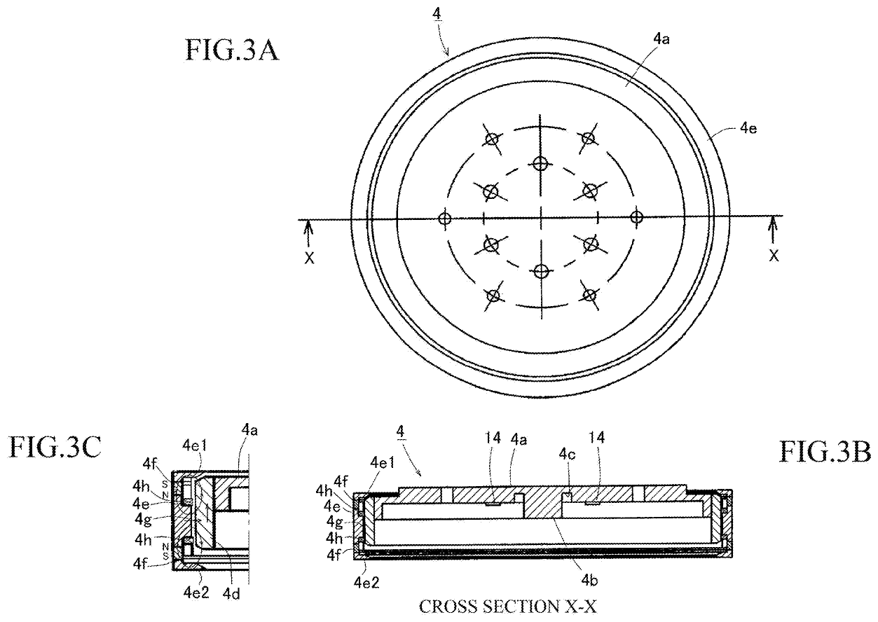

As illustrated in FIGS. 3A and 3B, the electromagnetic clutch mechanism 4 is disposed downstream of the output member 3 in the drive transmission path so that the movable member 4a (output-side member) is movable in the axial direction. A locking part 14 is provided on the movable member 4a on a surface opposing the clutch plate 13. The output member 3 and the movable member 4a are configured to rotate integrally when the clutch plate 13 is pressed against the locking part 14.

A guide shaft 4b protrudes toward the output member 3 from a center of rotation of the movable member 4a. The clutch plate 13 is assembled to the output member 3 opposed to the guide shaft 4b, and a shaft hole 13a which allows insertion and removal of the guide shaft 4b is provided in the clutch plate 13. A sliding cylinder 13b is fitted into the shaft hole 13a. The movable member 4a is moved in the axial direction while being guided by the sliding cylinder 13b to which the guide shaft 4b is opposed, so that a contact/separation movement is made between the clutch plate 13 and the locking part 14. A circumferential groove 4c configured to avoid interference with the sliding cylinder 13b may be provided on an outer periphery of the guide shaft 4b.

As illustrated in FIG. 3C, an annular movable yoke 4d is integrally assembled to an outer peripheral surface of the movable member 4a. A stationary yoke 4e is provided in the speed reducer housing 5b so as to surround the movable yoke 4d. The stationary yoke 4e is provided so that both side leg portions (a first leg portion 4e1 and a second leg portion 4e2) formed in an angular U-shape are opposed to the movable yoke 4d via a clearance so as to form an annular magnetic path.

A pair of permanent magnets 4f disposed with the same magnetic poles (for example, N poles) opposed each other are assembled to parts of the stationary yoke 4e. The stationary yoke 4e is provided with a protrusion 4g between the pair of permanent magnets 4f so as to extend toward the movable yoke 4d provided radially inside. A pair of coils 4h wound in an annular shape adjacent to the protrusion 4g are disposed so that air-core portions are opposed to the movable yoke 4d. The pair of coils 4h are coils wound in the same direction and are energized in the same direction. Therefore, magnetic paths generated by the energization of the respective coils 4h are also generated in the same direction. By switching the direction of energization of the pair of coils 4h, the magnitude of attraction powers of the both side leg portions 4e1 and 4e2 of the stationary yoke 4e are varied, and the movable yoke 4d is moved in the axial direction to achieve switching between the drive transmission state and the drive cut-off state.

As illustrated in an enlarged sectional view of FIG. 3C, when it is assumed that the pair of permanent magnets 4f are disposed opposite to each other with the direction of the magnetic poles reversed (for example, in such a manner that N poles are opposed to each other) in the parts of the stationary yoke 4e, a magnetic path going around counterclockwise is formed for the permanent magnet 4f located above the protrusion 4g and a magnetic path going around clockwise is formed for the permanent magnet 4f located below the protrusion 4g respectively between the stationary yoke 4e and the movable yoke 4d. At this time, a magnetic path in the direction toward the movable yoke 4d is also formed in the protrusion 4g of the stationary yoke 4e.

When the pair of coils 4h are energized in a direction in which a counterclockwise magnetic flux is generated, the magnetic path of the permanent magnet 4f above the protrusion 4g, going around counterclockwise, is overlapped with the magnetic path of the coil 4h, so that the magnetic flux passing through the first leg portion 4e1 of the stationary yoke 4e increases. In contrast, the magnetic path of the permanent magnet 4f below the protrusion 4g, going around clockwise, is counterbalanced with the magnetic path of the coil 4h, so that the magnetic flux passing through the second leg portion 4e2 is reduced. Consequently, the movable yoke 4e is attracted by the first leg portion 4e1 and the output member 3 is moved upward in the axial direction (the direction indicated by an arrow in FIG. 3C). Alternatively, when the pair of coils 4h are energized in a direction in which a clockwise magnetic flux is generated, the magnetic path of the permanent magnet 4f above the protrusion 4g, going around counterclockwise, is counterbalanced with the magnetic path of the coil 4h, so that the magnetic flux passing through the first leg portion 4e1 of the stationary yoke 4e is reduced. In contrast, the magnetic path of the permanent magnet 4f below the protrusion 4g, going around clockwise, is overlapped with the magnetic path of the coil 4h, so that the magnetic flux passing through the second leg portion 4e2 is increased. Consequently, the movable yoke 4e is attracted by the second leg portion 4e2 and the output member 3 is moved downward in the axial direction (opposite to the direction indicated by an arrow in FIG. 3C).

Further, even if energization of the coil 4h is stopped after the movable yoke 4e is attracted by the first leg portion 4e1 or the second leg portion 4e2 and the output member 3 is moved upward or downward in the axial direction, the permanent magnet 4f and the movable yoke 4e attract each other to hold position of the output member 3 as-is. In other words, since the electromagnetic clutch mechanism 4 consumes electric power only at the moment when the output member 3 is moved, it is preferable in a field in which reduction of power consumption is desirable like mobile devices.

FIGS. 2A and 2B illustrate a connecting state of the electromagnetic clutch mechanism 4. The movable yoke 4d is attracted by the second leg portion 4e2 of the stationary yoke 4e, the movable member 4a is moved in the axial direction toward the output member 3, and the guide shaft 4b is deeply advanced into the sliding cylinder 13b, so that a state in which the clutch plate 13 is pressed against the locking part 14 is achieved.

In FIGS. 2A and 2B, when the motor 1 starts, the rotor yoke 7a rotates together with the eccentric shaft 8, and the first bearing 9a and the second bearing 10a that come into contact with outer peripheries of the first and second eccentric cam portions 8a and 8b follow to rotate. At this time, the first bearing 9a and the second bearing 10a oscillate in the radial direction by an amount of eccentricity of the first and second eccentric cam portions 8a and 8b, and the first external gear 9 and the second external gear 10 mesh with the internal gear 11 opposed thereto at a position shifted from each other by 180° in phase, thereby rotating in a predetermined direction.

In this way, the first and second external gears 9, 10 having the trochoid tooth shape revolve around the eccentric shaft 8 by the rotation of the rotor yoke 7a. In association with the revolution movement (oscillatory movement), the first and second external gears 9 and 10 perform a rotation movement at a rotating speed (number of rotations) which is reduced in speed to a level lower than the revolution speed by meshing with the internal gear 11. Subsequently, the rotation movement of the first and second external gears 9 and 10 as described above is transmitted to the output member 3, and a rotation output reduced in speed is output from the output member 3. The rotational output reduced in speed is outputted from the output member 3 to the movable member 4a connected by the electromagnetic clutch mechanism 4.

FIGS. 1A and 1B illustrate a state in which the electromagnetic clutch mechanism 4 is in a non-connecting state. In FIGS. 2A and 2B, by reversing the direction of energization through the coil 4h, the movable yoke 4d is attracted by the first leg portion 4e1 of the stationary yoke 4e, and the movable member 4a is moved in the axial direction away from the output member 3, and thus the depth of advancement of the guide shaft 4b into the sliding cylinder 13b is reduced, so that a state in which the clutch plate 13 is separated from the locking part 14 is achieved. Even when the motor 1 is in the state of standstill at this time, by setting the movable member 4a on the output side and the output member 3 of the speed reducer 2 into the drive cut-off state by the electromagnetic clutch mechanism 4, the load from the output side can be reduced and thus the output member 3 can be rotated.

As described thus far, only by switching the direction of energization of an electromagnet 4i of the electromagnetic clutch mechanism 4, the magnitude of the attraction power between the movable yoke 4d and the stationary yoke 4e having the both side leg portions 4e1 and 4e2 disposed so as to be opposed to each other is varied to move the movable yoke 4d in the axial direction together with the output member 3 to achieve switching between the drive transmission state and the drive cut-off state. Therefore, by setting the movable member 4a of the electromagnetic clutch mechanism 4 and the output member 3 of the speed reducer 2 into the drive cut-off state, the movable member 4a which is a member on the output side with respect to the speed reducer 2 can be rotated with a load reduced from the output side even when the motor is in a state of standstill. Further, since the outer diameter of the motor 1 is formed to be larger than the outer diameter of the speed reducer 2, by disposing the electromagnetic clutch mechanism 4 in the free space S in the axial direction which is formed in the speed reducer 2 of the motor 1, a compact and flat motor with a speed reducer which achieves a reduction in thickness in the axial direction may be provided.

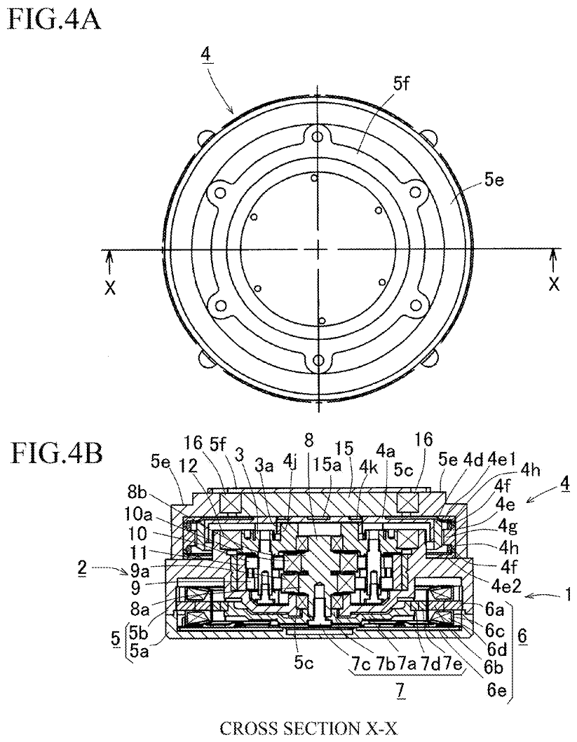

Next, another example of the motor with a speed reducer will be described with reference to FIGS. 4A and 4B. It should be noted that the same members as the motor with a speed reducer illustrated in FIG. 1A to FIG. 3C are denoted by the same reference numerals and description is incorporated. Although the electromagnetic clutch mechanism 4 is provided in the final output stage of the speed reducer 2 in the example described above, an output-side rotating member (rotating member 15) may be provided downstream of the electromagnetic clutch mechanism 4 (movable member 4a) in the drive transmission path. Since the configurations of the motor 1 and the speed reducer 2 are the same, the description will be applied thereto, and the configurations of the electromagnetic clutch mechanism 4 and the rotating member 15 will be described.

In FIGS. 4A and 4B, first recess-projection portions 3a are formed at predetermined pitches in the circumferential direction on an end face of a boss portion of the output member 3, and second recess-projection portions 4j are provided at predetermined pitches in the circumferential direction on an end face of the movable member 4a of the electromagnetic clutch mechanism 4 opposing thereto. The first recess-projection portion 3a and the second recess-projection portion 4j are always meshed each other by the projecting portions and the recessed portions which oppose each other (the recessed portion 3a and the projecting portion 4j are illustrated in FIG. 4B). Even when the movable member 4a is moved in the axial direction, the meshing between the first recess-projection portion 3a and the second recess-projection portion 4j does not come off. The annular movable yoke 4d is provided on the outer periphery of the movable member 4a. Also, a clutch housing 5e is provided in the speed reducer housing 5b. The stationary yoke 4e is assembled to an inner peripheral surface of the clutch housing 5e.

The configuration of the stationary yoke 4e is the same as that of FIG. 3C, and the stationary yoke 4e is provided so that the both side leg portions (the first leg portion 4e1 and the second leg portion 4e2) formed in an angular U-shape are opposed to the movable yoke 4d via a clearance so as to form an annular magnetic path. The pair of permanent magnets 4f disposed with the same magnetic poles opposing each other are assembled to parts of the stationary yoke 4e. The stationary yoke 4e is provided with the protrusion 4g between the pair of permanent magnets 4f so as to extend toward the movable yoke 4d provided radially inside. The pair of coils 4h wound in an annular shape adjacent to the protrusion 4g are disposed so that air-core portions are opposed to the movable yoke 4d. The pair of coils 4h are coils wound in the same direction and are energized in the same direction. Therefore, magnetic paths generated by the energization of the respective coils 4h are also generated in the same direction. By switching the direction of energization of the pair of coils 4h, the magnitude of attraction powers of the both side leg portions 4e1 and 4e2 of the stationary yoke 4e is varied, and the movable yoke 4d is moved in the axial direction to achieve switching between the drive transmission state and the drive cut-off state.

The rotating member 15 is rotatably supported by a rolling bearing 16 in an opening of the clutch housing 5e. The rolling bearing 16 is retained by a pressing plate 5f. The rotating member 15 is disposed so as to be opposed to the movable member 4a. A projecting portion 15a is provided on an opposing surface of the rotating member 15, and a recessed portion 4k is provided on an opposing surface of the movable member 4a. The projecting portion 15a and the recessed portion 4k are switched between a meshing state (connecting state) in which the recess-projection engagement is achieved and a non-meshing state (non-connecting state) in which the recess-projection engagement is released and thus the recess and projection are separated from each other by the axial movement of the movable member 4a.

When the pair of coils 4h illustrated in FIG. 3C are energized in the direction in which the counterclockwise magnetic flux is generated, the magnetic path of the permanent magnet 4f above the protrusion 4g, going around counterclockwise, is overlapped with the magnetic path of the coil 4h, so that the magnetic flux passing through the first leg portion 4e1 of the stationary yoke 4e increases. In contrast, the magnetic path of the permanent magnet 4f below the protrusion 4g goes around clockwise and thus is counterbalanced with the magnetic path of the coil 4h, thereby reducing the magnetic flux passing through the second leg portion 4e2. Consequently, the movable yoke 4e is attracted by the first leg portion 4e1 and the output member 3 is moved upward in the axial direction (the direction indicated by an arrow in FIG. 3C). Accordingly, the recess-projection engagement of the projecting portion 15a of the rotating member 15 with respect to the recessed portion 4k of the movable member 4a illustrated in FIG. 4B is achieved. At this time, the first recess-projection portion 3a of the output member 3 and the second recess-projection portion 4j of the movable member 4a are in a state of being meshed with each other. Therefore, when the motor 1 is driven to rotate, the first and second external gears 9, 10 having the trochoid tooth shape revolve around the eccentric shaft 8 by the rotation of the rotor yoke 7a. In association with the revolution movement (oscillatory movement), the first and second external gears 9 and 10 perform a rotation movement at a rotating speed (number of rotations) which is reduced in speed to a level lower than the revolution speed by meshing with the internal gear 11. Subsequently, the rotation movement of the first and second external gears 9 and 10 as described above is transmitted to the output member 3 and the movable member 4 mashing therewith, and a rotation output reduced in speed is output from the rotating member 15.

When the pair of coils 4h in FIG. 3C are energized in the direction in which the clockwise magnetic flux is generated, the magnetic path of the permanent magnet 4f above the protrusion 4g, going around counterclockwise, is counterbalanced with the magnetic path of the coil 4h, so that the magnetic flux passing through the first leg portion 4e1 of the stationary yoke 4e is reduced. In contrast, the magnetic path of the permanent magnet 4f below the protrusion 4g, going around clockwise, is overlapped with the magnetic path of the coil 4h, so that the magnetic flux passing through the second leg portion 4e2 is increased. Consequently, the movable yoke 4e is attracted by the second leg portion 4e2 and the output member 3 is moved downward in the axial direction (opposite to the direction indicated by an arrow in FIG. 3C). Accordingly, the recess-projection engagement between the recessed portion 4k of the movable member 4a and the projecting portion 15a of the rotating member 15 illustrated in FIG. 4B is released. At this time, even when the motor 1 is in the state of standstill, by setting the rotating member 15 and the movable member 4a of the electromagnetic clutch mechanism 4 in the drive cut-off state, the rotating member 15 disposed downstream of the electromagnetic clutch mechanism 4 in the drive transmission path can be rotated in a state in which the load is reduced from the output side.

It should be noted that although the pair of coils 4h provided in the electromagnetic clutch mechanism 4 are energized at the same time in the examples described above, a configuration in which only one of the coils 4h (a magnetic path amplified by the magnetic path formed by the permanent magnet 4f, or a magnetic path counterbalanced thereby) is energized is also applicable. For example, when the movable member 4a positioned on the upper side is moved to the lower side as illustrated in FIG. 3C, the counterclockwise magnetic flux of the upper permanent magnet 4f is cancelled by energizing only the upper coil 4h. Accordingly, the movable member 4a is attracted by the lower permanent magnet 4f, so that the movable member 4a can be moved to the lower side. Although the above-described speed reducer 2 is a trochoid-type speed reducer, the type of the speed reducer is not limited thereto, and may be, for example, a planetary gear speed reducer. In this case, a sun gear shaft may be provided instead of the eccentric shaft 8 to be coupled to the rotor yoke 7a to cause a plurality of external gears revolve about a sun gear as planetary gears, so that the output member provided with the internal gear may be rotated relatively at a reduced speed.

In the above-described example, the inner-rotor type motor has been used for describing the motor 1. However, an outer-rotor type motor is also applicable. Besides the brushless motor, other types of motors such as a brushed motor or an ultrasonic motor or a driving source may also be used.

What is claimed is:

1. A motor with a speed reducer, comprising:
a motor configured to drive to rotate an input shaft;
a speed reducer configured to rotate an output member at a reduced speed via a gear mechanism about the input shaft; and
an electromagnetic clutch mechanism,
wherein the motor is formed to have an outer diameter larger than an outer diameter of the speed reducer, and
the electromagnetic clutch mechanism is disposed in an axial projection space of the motor with respect to the speed reducer to achieve switching a state of the output member of the speed reducer with respect to an output-side member disposed downstream of the output member in a drive transmission path between a drive transmission state and a drive cut-off state.

2. The motor with a speed reducer according to claim 1, wherein the electromagnetic clutch mechanism comprises:
a movable member disposed so as to be opposed to the output member in an axial direction and provided so as to allow a contact/separation movement;
a movable yoke assembled to the movable member;
a stationary yoke including both side leg portions having an angular U-shape disposed so as to be opposed to the movable yoke via a clearance;
a pair of permanent magnets disposed on part of the stationary yoke in a direction in which the same poles oppose each other;
a protrusion disposed on the stationary yoke between the pair of permanent magnets so as to protrude toward the movable yoke; and
a pair of coils disposed adjacent to the protrusion and turned in the same direction with air-core portions thereof so as to be opposed to the movable yoke,
wherein a direction of energization of the coils is switched to vary a magnitude of an attraction power of both side leg portions on the stationary yoke and move the movable yoke in the axial direction to achieve switching between the drive transmission state and the drive cut-off state to the output-side member.

3. The motor with a speed reducer according to claim 2, wherein a clutch plate is coaxially provided over the output member, and switching between the drive transmission state and the drive cut-off state is achieved by the contact/separation movement between the clutch plate and the movable member.

4. The motor with a speed reducer according to claim 1, wherein the speed reducer comprises:
external gears configured to revolve around the input shaft and an internal gear configured to mesh with the external gears and
the output member configured to rotate with the rotation of the external gears relatively at a reduced speed via the internal gear.

5. The motor with a speed reducer according to claim 1, wherein the input shaft is an eccentric shaft or a sun gear coupled to a rotor yoke of the motor, and the eccentric shaft or the sun gear is used as an input to the external gears.

6. A motor with a speed reducer, comprising:
a motor configured to drive to rotate an input shaft;
a speed reducer configured to rotate an output member at a reduced speed via a gear mechanism about the input shaft;
a movable member constantly meshing with the output member; and
an electromagnetic clutch mechanism,
wherein the motor is formed to have an outer diameter larger than an outer diameter of the speed reducer, and
the electromagnetic clutch mechanism is disposed in an axial projection space of the motor with respect to the speed reducer to achieve switching between a drive transmission state and a drive cut-off state by an contact/separation movement between the movable member and the output-side rotating member disposed downstream of the movable member in a drive transmission path.

7. The motor with a speed reducer according to claim 6, wherein the speed reducer comprises:
external gears configured to revolve around the input shaft and an internal gear configured to mesh with the external gears and
the output member configured to rotate with the rotation of the external gears relatively at a reduced speed via the internal gear.

8. The motor with a speed reducer according to claim 6, wherein the input shaft is an eccentric shaft or a sun gear coupled to a rotor yoke of the motor, and the eccentric shaft or the sun gear is used as an input to the external gears.
